(19) United States
(12) Patent Application Publication
(10) Pub. No.: US 2014/0133535 A1
(43) Pub. Date: May 15, 2014

(54) Signal Classification for Adaptive Signal Detection

(71) Applicant: MITSUBISHI ELECTRIC RESEARCH LABORATORIES, INC., Cambridge, MA (US)

(72) Inventors: Philip Orlik, Cambridge, MA (US); Ramesh Annavajjala, Natick, MA (US)

(73) Assignee: Mitsubishi Electric Research Laboratories, Inc., Cambridge, MA (US)

(21) Appl. No.: 13/677,543

(22) Filed: Nov. 15, 2012

(51) Int. Cl. H04B 17/00

(52) U.S. Cl. CPC H04B 17/0042
USPC 375/224

(57) ABSTRACT

Signal received in a wireless network are detected by arranging samples of the signal in a set of windows. For each window, estimating interference, an average signal, noise and interference ratio (SINR), and a channel. For each window, also classifying a type of a process of a set of processes of a receiver. Then, selecting the process for each windows according to the type to detect the signal in the window.

### FIELD OF THE INVENTION

This invention relates generally to detecting signals in a wireless network, and more particularly to detecting signals using a set of adaptive receiver processes.

### BACKGROUND OF THE INVENTION

Signal Classification for Noise-Limited Scenario

In a baseband, a wireless communication network has the following transmit-receive signal model with complex values

where y is a channel output, h is a channel gain, s is a modulation input, and n is channel noise.

With Gaussian channel noise and perfect receiver channel, state information (CSI), an optimal receiver for the above signal model is a zero-forcing, (ZF) receiver followed by a signal slicer. The ZF receiver can be expressed in a compact-form as

$${\hat{s}}_{ZF} = {argmin}_{x ∈ S} {‖ \frac{y}{h} - x ‖}^{2} ,$$

where S is a signal constellation, i.e., the set of valid signal points.

If a minimum mean-square error (MMSE) receiver is used, a decision produced by the MMSE receiver is

$${\hat{s}}_{MMSE} = {argmin}_{x ∈ S} {‖ \frac{{yh}^{*}}{{\vert h \vert}^{2} + {σ}_{N}^{2}} - x ‖}^{2}$$

where σ_{N}² is a variance of the noise n

σ_{N}²=E└|n|²┘.

In the absence of noise, the MMSE estimate is

$$\frac{{yh}^{*}}{{\vert h \vert}^{2} + {σ}_{N}^{2}} = ( \frac{{\vert h \vert}^{2}}{{\vert h \vert}^{2} + {σ}_{N}^{2}} ) s ,$$

which is strictly less than s. That is, the estimate is biased, and signal scaling leads to performance degradation for higher order constellations.

Signal Classification in the Presence of Noise and Interference

In the presence of interference, the received signal model is

y=h×s+g×u+n,

where, y, h and s are defined above, u an interfering modulation symbol, and g is the channel between an interfering transmitter and the receiver.

If the receiver knows the interfering channel and the interfering modulation symbol, then an optimal detector cancels the contribution of g×u from y before performing a zero-forcing detection.

That is,

$${\hat{s}}_{ZF} = {argmin}_{x ∈ S} {‖ \frac{y - g \times u}{h} - x ‖}^{2}$$

is the ZF detector output.

If the interfering channel and the interference constellation type, i.e., u coming from QPSK or 16-QAM or 64-QAM constellation, are known, then the optimal detector performs joint detection of s and u

$$( {\hat{s}}_{ML} , {\hat{u}}_{ML} ) = {argmin}_{x ∈ S , v ∈ {S}_{u}} {‖ y - h \times x - g \times v ‖}^{2} ,$$

where Sᵤ is the signal constellation of the interference.

If the constellation of u is unknown, then a linear MMSE solution produces an estimate of s that is mean-square optimal. That is,

$${\hat{s}}_{MMSE} = {argmin}_{x ∈ S} {‖ \frac{{yh}^{*}}{{\vert h \vert}^{2} + {\vert g \vert}^{2} + {σ}_{N}^{2}} - x ‖}^{2} .$$

A signal classifier that classifies the received signal according to whether the channel and/or the modulation symbol of the interference is known can enable the receiver perform optimal detection on a symbol-by-symbol basis.

Signal Classification with Multiple Receiver Antennas

Unlike the scenarios above, a single antenna transmission with multiple receiver antennas in the presence of multiple interferers is now described. The received signal model is

$$\underline{y} = [ \begin{matrix}{y}_{1} \\ {y}_{2} \\ ⋮ \\ {y}_{L}\end{matrix} ] = [ \begin{matrix}{h}_{1} \\ {h}_{2} \\ ⋮ \\ {h}_{L}\end{matrix} ] \times s + {\sum }_{k = 1}^{{N}_{l}} [ \begin{matrix}{g}_{1} ( k ) \\ {g}_{2} ( k ) \\ ⋮ \\ {g}_{L} ( k )\end{matrix} ] \times {u}_{k} + [ \begin{matrix}{n}_{1} \\ {n}_{2} \\ ⋮ \\ {n}_{L}\end{matrix} ]$$

where L is the number of receiver antennas, the channel gains h₁,h₂, . . . , h_{L} are the channel coefficients between the desired transmitter and the desired receiver, uₖ is the k-th interfering transmitter, g₁(k),g₂(k), . . . , g_{L}(k) are the channel gains between the k^{th} interferer and the desired receiver, and n₁ is the additive noise on the l^{th} receiver antenna.

The receiver that completely ignores the interference component is the maximal-ratio combining (MRC) receiver. The soft signal estimate of the MRC receiver is given by

$${\hat{s}}_{soft , MRC} = \frac{{\sum }_{l = 1}^{L} {y}_{l} {h}_{l}^{*}}{{\sum }_{l = 1}^{L} {\vert {h}_{l} \vert}^{2}} ,$$

and the corresponding received SINR is

$${Γ}_{MRC} = \frac{{‖ \underline{h} ‖}^{4}}{{\underline{h}}^{Herm} ( {\sum }_{k = 1}^{{N}_{l}} \underline{g} ( k ) {\underline{g}}^{Herm} ( k ) ) \underline{h} + {σ}_{n}^{2} {‖ \underline{h} ‖}^{2}} .$$

Note that in the absence of any interference, the above SINR simplifies to

$${Γ}_{MRC} = \frac{{‖ \underline{h} ‖}^{2}}{{σ}_{n}^{2}} ,$$

which is the SNR corresponding o the best possible receiver.

Note that the presence or absence of interference completely changes the distribution properties of the SINR. In the absence of interference, the SINR (or SNR) is distributed as Chi-squared (or Gamma random variable) with 2L degrees of freedom for uncorrelated zero-mean and unit-variance complex-Gaussian channel gains. The peak of SNR probability distribution function (pdf) shifts to the right as the number of antennas increases. On the other hand, in the presence of interference the SINR is no more Chi-square distributed. With increasing number of interferers, the SINR pdf shifts to the left, and the average SINR also decreases.

Instead of MRC, if an optimal receiver weight w is applied, the soft symbol estimate with this weight is given by

$$\begin{matrix}{\hat{s}}_{soft , rx - weight} = {\underline{w}}^{Herm} \underline{y} \\ = ( {\underline{w}}^{Herm} \underline{h} ) s + {\sum }_{k = 1}^{{N}_{l}} {\underline{w}}^{Herm} \underline{g} ( k ) {u}_{k} + {\underline{w}}^{Herm} \underline{n}\end{matrix}$$

As an example, the interference-rejection combining linear receiver has the following weight vector:

$$\underline{w} = {( {\underline{h}}^{Herm} \underline{h} + {\sum }_{k = 1}^{{N}_{l}} {\underline{g}}^{Herm} ( k ) \underline{g} ( k ) + {σ}_{n}^{2} {I}_{L} )}^{- 1} \underline{h}$$

The SINR with optimally chosen w is

$${Γ}_{rx - weight} = \frac{{‖ \underline{{w}^{Herm} h} ‖}^{2}}{{\underline{w}}^{Herm} ( {\sum }_{k = 1}^{{N}_{l}} \underline{g} ( k ) {\underline{g}}^{Herm} ( k ) ) \underline{w} + {σ}_{n}^{2} {‖ \underline{w} ‖}^{2}}$$

Clearly, by building knowledge of the distribution of the received SINR over a large observation window, the receiver can make an intelligent decision in using the right receiver type for the prevailing channel conditions.

### SUMMARY OF THE INVENTION

Signal received in a wireless network are detected by arranging samples of the signal in a set of windows. For each window, estimating interference, an average signal, noise and interference ratio (SINR), and a channel. For each window, also classifying a type of a process of a set of processes of a receiver. Then, selecting the process for each windows according to the type to detect the signal in the window

### BRIEF DESCRIPTION OF THE DRAWINGS

FIG. 1 is a schematic of an OFDM signal processed by embodiments of the invention; and

FIG. 2 is a flow diagram of a method for detecting signals according to embodiments of the invention.

### DETAILED DESCRIPTION OF THE PREFERRED EMBODIMENTS

Signal Classification for Adaptive Signal Reception

The embodiments of the invention provide a method for classifying a signal observed adaptively over time-frequency windows in a receiver, and then to detect the signal in each Window based on a receiver process type.

We focus on a signal that is encoded using orthogonal frequency-division multiplexing (OFDM), wherein the time-frequency window corresponds to a set of OFDM symbols in a time domain, and a set of sub-carriers in a frequency domain.

The first step to signal classification is the estimation of both instantaneous (short term) as well as average (long term) channel parameters, including an average signal power, an average noise power, and an average interference power. Instantaneous channel parameters include a complex-valued channel gain between a transmitter and the receiver.

Estimation of Noise Power

The null-subcarriers, i.e., the subcarriers that are not used for data or pilot transmission, in the OFDM signal can be used to estimate the average noise power per subcarrier.

Estimation of Noise and Interference Power Some subcarriers are not allowed for modulation. That is, no modulated data are transmitted over these subcarriers. By measuring the total received power on these subcarriers, one can estimate the interference and noise Power.

Estimation of Signal, Noise, and Interference Power

The signal, noise, and interference power is the total power received on modulated data subcarriers.

Using the above three estimates, it is possible to individually estimate the signal power, noise power and interference power.

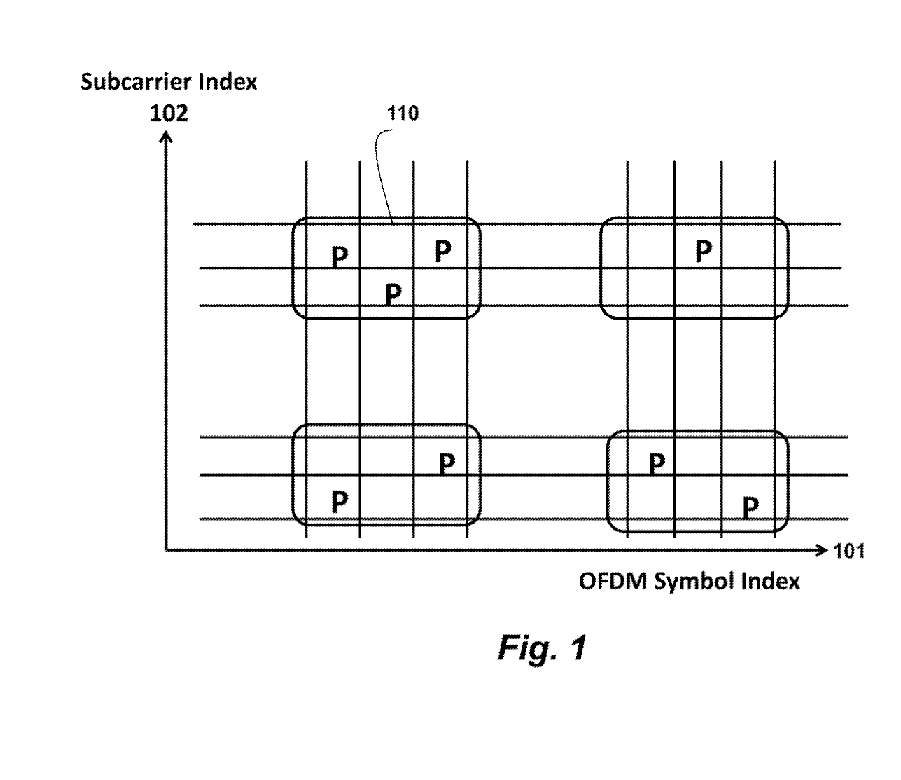

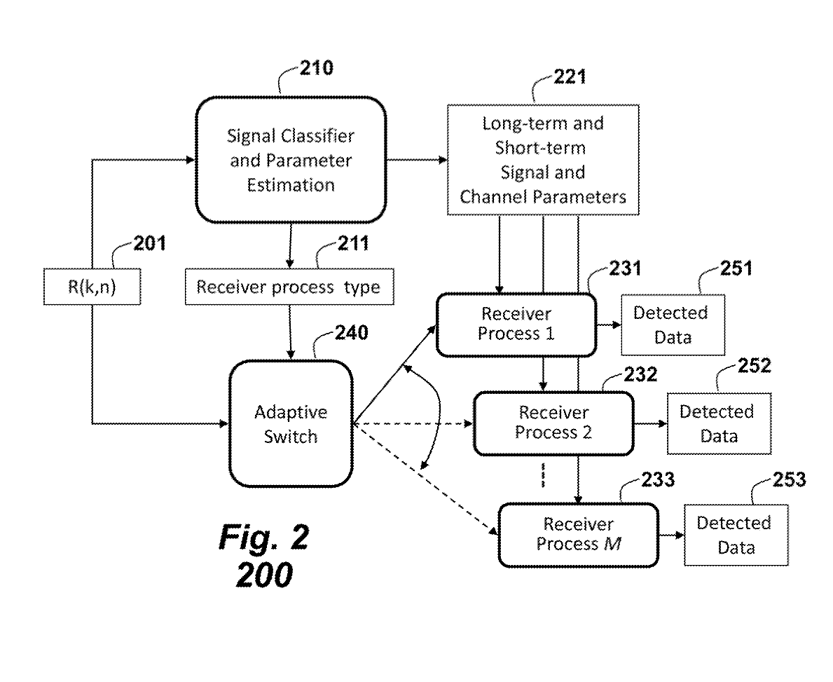

FIG. 1 shows a time-frequency view of the OFDM signals. Here, the OFDM symbols 102 are modulated in the frequency-domain over subcarriers 102. A signal classifier 210 (see FIG. 2) has access to a. base-band received signal R(k, 201, where k is the frequency index and n is the OFDM symbol index, over a number of OFDM symbols.

Samples of the signal are partitioned into a number of windows 110, each window contains predetermined number subcarriers over a pre-determined number of OFDM symbols. Within each window, some known data symbols (also referred to as “pilots P”) are used for signal estimation purposes. It should be noted that the invention can also be used with other signaling modalities, such as Orthogonal Frequency-Division Multiple Access (OFDMA), and other estimation techniques.

FIG. 2 shows the operation of a receiver including an adaptive signal classifier according to embodiments of the invention. As used herein, adaptive mean the receiver adjusts to the dynamics of the received signal over time, as the channel varies.

The classifier based signal detection method is described as follows. The step of the method can be performed in a receiver including a processor, memory, and input/output interfaces as known in the art.

Samples of a received base-band signal R(k, n) 201, where k is the sub-carrier index and n is the OFDM symbol index, are arranged in a set of observation windows W, where within each window includes a predetermined number of samples of the signal R(k, n).

For each window, we obtain an estimate 210 of the channel, an estimate of the interference, an average signal, noise and interference power (SINR). We also obtain the estimate of the SINR from these average signal power, noise power and interference power estimates.

The estimated SINR on window w is denoted by Γ(w), and the estimated channel over window w is denoted by g(w).

With W windows, the SINRs Γ(1), . . . , Γ(W) are used to construct a histogram of the SINR stored in a memory.

The SINR histogram enables us characterize the channel experienced by the received samples R(k, n) during the observation window.

We also obtain various short and long terms statistics 221 of the SINR, for example, the average SINR and the probability that the SINR is less than a predefined threshold, also-called the SINR outage probability,

The histogram enables us to estimate the types 211 of an optimal process of a set of process 231-233 be used for detecting the signals 251-252. The process types are fed to an adaptive switch 240, as each of the samples in each window are received and processed.

The parameters 221 are fed to the processes associated with various types of processes.

For example, we have a set of three process types:
a) ZF process 231;
b) MMSE process 232; and
c) interference rejection (IR) process 233.

Additional process types can also be defined.

ZF process

We select two SINR thresholds. We denote these thresholds by Γ_{—}1 and Γ_{—}2, such that Γ_{—}1 is less than Γ_{—}2.

We maintain a list of all the windows for which Γ(w) is not less than Γ_{—}2. The samples of these windows and the corresponding channel estimates are fed to the ZF process 231. The ZF process operates on each of these windows separately. For each window, the corresponding channel estimate is used to detect the signals 251 as described above.

MMSE Process

We maintain a list all the windows for which Γ(w) is between Γ_{—}1 and Γ_{—}2. The samples of these windows and the corresponding channel estimates are fed to the linear MMSE process 232. The MMSE process operates on each of these windows separately. For each window, the corresponding channel estimate and the noise variance are used to detect the signals 252.

Interference Rejection Process

We maintain a list of all the windows for which Γ(w) is less than Γ_{—}1. The samples of these windows and the corresponding channel estimates are fed to the interference rejection (IR) process. This process can use interference rejection combining (IRC), a maximum likelihood (ML) process, or any other receiver process with optimal interference cancelation. The IR process operates on each of these windows separately. For each window, the corresponding channel estimate of the signal, an interfering user, the noise and interference power are used to detect the signals.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

1. A method for detecting signal received in a wireless network, comprising the step of:
arranging samples of the signal in a set of windows;
estimating, for each window, interference, an average signal, noise and interference ratio (SINR), and a channel;
classifying, for each window, a type of a process of a set of processes of a receiver based on the interference, the average signal, the noise and the SINR, and the channel; and
selecting the process for each windows according to the type to detect the signal in the window, wherein the steps are in the receiver.

2. The method of claim 1, wherein the signal R(k, n) is an orthogonal frequency-division multiplexing (OFDM) signal, where k is a sub-carrier index and n is a symbol index.

3. The method of claim 1, wherein each window includes a predetermined number samples.

4. The method of claim 1, wherein le steps are adaptive to varying channel conditions.

5. The method of claim 1, wherein instantaneous and average channel parameters are estimated.

6. The method of claim 5, wherein the parameters are for noise power, noise and interference power, signal, noise, and interference power.

7. The method of claim 1, wherein the signal includes pilot symbols.

8. The method of claim 5, further comprising:
constructing a histogram from the parameters.

9. The method of claim 1, further comprising:
specifying a first threshold and a second threshold greater than the first threshold;
using a zero forcing process if the SNIR is not less than the second threshold;
using a minimum mean-square error process if the SNIR is between the first and second threshold; and
using an interference rejection process if the SNIR is less than the first threshold.
